(19) United States
(12) Patent Application Publication
(10) Pub. No.: US 2012/0075213 A1
(43) Pub. Date: Mar. 29, 2012

(54) MULTI-HOST TOUCH CONTROL DISPLAY DEVICE

(75) Inventors: Chao-Wei HUANG, New Taipei City (TW); Kuo-Liang YAO, New Taipei City (TW); Tsai-Chin CHANG, New Taipei City (TW)

(73) Assignee: ACER INCORPORATED, New Taipei City (TW)

(21) Appl. No.: 13/213,928

(22) Filed: Aug. 19, 2011

(30) Foreign Application Priority Data
Sep. 23, 2010 (TW) 099132168

(51) Int. Cl. G06F 3/041

(52) U.S. Cl. 345/173

(57) ABSTRACT

A multi-host touch control display device is to be connected to a plurality of host devices for touch controlling the host devices, and includes a control unit, a touch screen unit and a switch unit. The control unit provides a switch control signal. The touch screen unit is for generating a touch control signal according to a touch event thereon. The switch unit is coupled electrically to the control unit for receiving the switch control signal therefrom, is further coupled electrically to the touch screen unit, and is to be coupled electrically to the host devices. The switch unit is operable to enable transmission between the touch screen unit and a selected one of the host devices according to the switch control signal received from the control unit such that the touch screen unit is able to transmit the touch control signal generated thereby to the selected one of the host devices.

### CROSS-REFERENCE TO RELATED APPLICATION

This application claims priority of Taiwanese Application No. 099132168, filed on Sep. 23, 2010, the disclosure of which is incorporated herein by reference.

### BACKGROUND OF THE INVENTION

1. Field of the Invention

The invention relates to a touch control display device, more particularly to a multi-host touch control display device.

2. Description of the Related Art

A state-of-the-art electronic device usually requires a proprietary control mechanism for controlling its operations. For instance, a digital television, a DVD player, a computer, or other multimedia device needs a corresponding proprietary control mechanism so as to permit user control thereof. Moreover, for easy and convenient user control, utilizing a touch control display device as a control mechanism has become a popular design choice. However, when it is desired to simultaneously use multiple electronic devices, and each of the electronic devices is equipped with its own touch control display device, it can hardly be said that operating these electronic devices is convenient. In addition, the overall cost for controlling these electronic devices is high.

### SUMMARY OF THE INVENTION

Therefore, the object of the present invention is to provide a multi-host touch control display device capable of servicing multiple host devices.

According to the present invention, there is provided a multi-host touch control display device to be connected to a plurality of host devices for touch controlling the host devices. The multi-host touch control display device includes a control unit, a touch screen unit and a switch unit.

The control unit is capable of providing a switch control signal.

The touch screen unit is for generating a touch control signal according to a touch event thereon.

The switch unit is coupled electrically to the control unit for receiving the switch control signal therefrom, is further coupled electrically to the touch screen unit, and is to be coupled electrically to the host devices. The switch unit is operable to enable transmission between the touch screen unit and a selected one of the host devices according to the switch control signal received from the control unit such that the touch screen unit is able to transmit the touch control signal generated thereby to the selected one of the host devices.

The advantage of the present invention lies in that with the collaboration between the control unit and the switch unit, the touch screen unit can service multiple host devices for a user to control these host devices to perform operations corresponding to touch events on a single touch screen unit, such that the cost for controlling multiple host devices is greatly reduced.

### BRIEF DESCRIPTION OF THE DRAWINGS

Other features and advantages of the present invention will become apparent in the following detailed description of the preferred embodiments with reference to the accompanying drawings, of which:

FIG. 1 is a system block diagram of the first preferred embodiment of a multi-host touch control display device according to the present invention; and

FIG. 2 is a system block diagram of the second preferred embodiment of a multi-host touch control display device according to the present invention.

### DETAILED DESCRIPTION OF THE PREFERRED EMBODIMENTS

Before the present invention is described in greater detail, it should be noted that like elements are denoted by the same reference numerals throughout the disclosure.

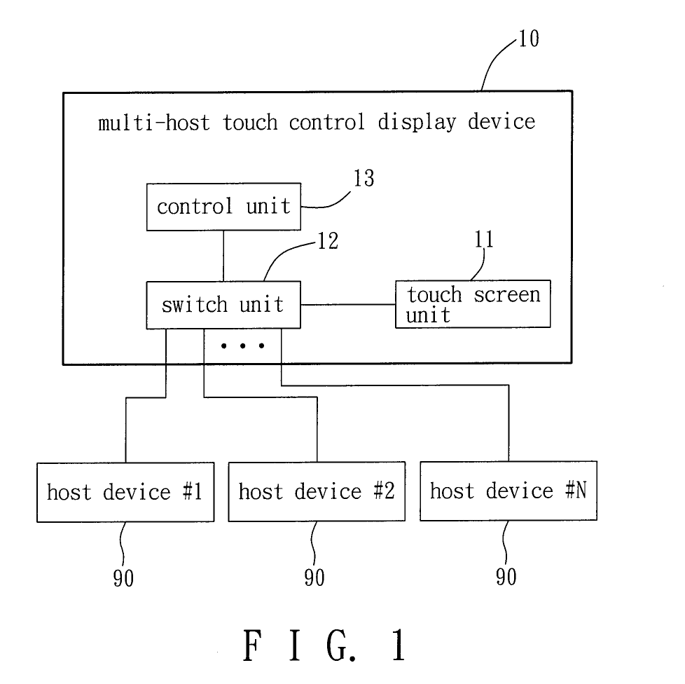

Referring to FIG. 1, the first preferred embodiment of a multi-host touch control display device 10 according to the present invention is shown to include a touch screen unit 11, a switch unit 12, and a control unit 13. The control unit 13 is capable of providing a switch control signal. The touch screen unit 11 is for generating a touch control signal according to a touch event thereon. The switch unit 12 is coupled electrically to the control unit 13 for receiving the switch control signal therefrom, is further coupled electrically to the touch screen unit 11, and is to be coupled electrically to a plurality of host devices 90, namely a host device #1, a host device #2, . . . and a host device #N in this embodiment. The switch unit 12 is operable to enable transmission between the touch screen unit 11 and a selected one of the host devices 90 according to the switch control signal received from the control unit 13 such that the touch screen unit 11 is able to transmit the touch control signal generated thereby to the selected one of the host devices 90. As such, the touch screen unit 11 is associated with the selected one of the host devices 90 and displays a screen based on data provided by the selected one of the host devices 90. The touch control signal generated by the touch screen unit 11 is associated with a corresponding operation of the selected one of the host devices 90. The switch unit 12 may be a USB switch unit, meaning that signal transmission between the switch unit 12 and each of the touch screen unit 11 and the host devices 90 is conducted over a universal serial bus (abbreviated as USB).

For example, if the control unit 13 provides the switch control signal to the switch unit 12 such that the switch unit 12 enables transmission between the touch screen unit 11 and a selected one of the host devices 90, e.g., the host device #1, the touch screen unit 11 is configured to be associated with the host device #1 and displays a screen (alternatively referred to as a first screen) based on data provided by the host device #1. When a touch event occurs, the touch screen unit 11 generates a touch control signal associated with a corresponding operation of the host device #1 (alternatively referred to as a first touch control signal). Subsequently, the switch unit 12 transmits the first touch control signal to the host device #1, such that the host device #1 is controlled to perform the corresponding operation according to the first touch control signal.

As another example, if the control unit 13 provides the switch control signal to the switch unit 12 such that the switch unit 12 enables transmission between the touch screen unit 11 and another selected one of the host devices 90, e.g., the host device #N, the touch screen unit 11 is configured to be associated with the host device #N and displays a screen based on data provided by the host device #N (alternatively referred to as a N^{th} screen). When a touch event occurs, the touch screen unit 11 generates a touch control signal associated with a corresponding operation of the host device #N (alternatively referred to as a N^{th} touch control signal). Subsequently, the switch unit 12 transmits the N^{th} touch control signal to the host device #N, such that the host device #N is controlled to perform the corresponding operation according to the N^{th} touch control signal.

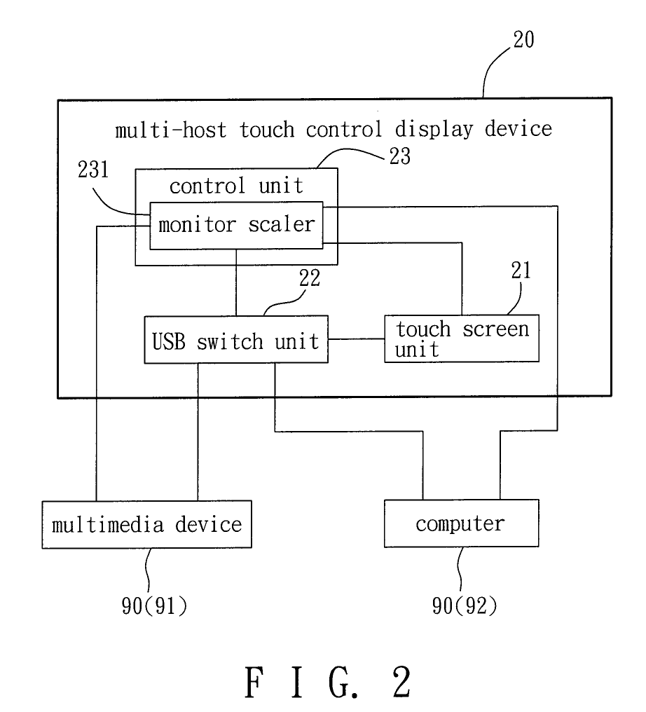

With reference to FIG. 2, the second preferred embodiment of a multi-host touch control display device 20 according to the present invention is shown to include a touch screen unit 21, a universal serial bus (USB) switch unit 22 and a control unit 23. The control unit 23 is capable of providing a switch control signal. The touch screen unit 21 is for generating a touch control signal according to a touch event thereon. The USB switch unit 22 is coupled electrically to the control unit 23 for receiving the switch control signal therefrom, is further coupled electrically to the touch screen unit 21, and is to be coupled electrically to a plurality of host devices 90, namely a multimedia device 91 and a computer 92 in this embodiment. The USB switch unit 22 is operable to enable transmission between the touch screen unit 11 and a selected one of the multimedia device 91 and the computer 92 according to the switch control signal received from the control unit 23 such that the touch screen unit 21 is able to transmit the touch control signal generated thereby to the selected one of the multimedia device 91 and the computer 92. The touch screen unit 11 is associated with the selected one of the multimedia device 91 and the computer 92 and displays a screen based on data provided by the selected one of the multimedia device 91 and the computer 92. The touch control signal generated by the touch screen unit 11 is associated with a corresponding operation of the selected one of the multimedia device 91 and the computer 92.

In this embodiment, the control unit 23 includes a monitor scaler 231 coupled electrically to the touch screen unit 21 and the USB switch unit 22, and to be coupled electrically to the multimedia device 91 and the computer 92. Connection between the monitor scaler 231 and the touch screen unit 21 is established via a serial peripheral interface (SPI) bus, while the connection between the touch screen unit 21 and the USB switch unit 22 is established via a universal serial bus (USB). The touch screen unit 21 is to be coupled to each of the multimedia device 91 and the computer 92 via an inter-integrated circuit (I2C) bus.

The multi-host touch control display device 20 of this embodiment is operable in an on-screen display (OSD) mode and a non-on-screen display mode.

When the multi-host touch control display device 20 operates in the on-screen display mode, the monitor scaler 231 transmits a screen adjustment enabling signal to the touch screen unit 21 via the serial peripheral interface bus so as to enable the touch screen unit 21 to transmit the touch control signal generated thereby to the monitor scaler 231 via the serial peripheral interface bus. The monitor scaler 231 scales the screen displayed on the touch screen unit 21 according to the touch control signal.

When the multi-host touch control display device 20 operates in the non-on-screen display mode, the monitor scaler 231 transmits a screen adjustment disabling signal to the touch screen unit 21 via the serial peripheral interface bus such that the touch screen unit 21 is able to transmit the touch control signal generated thereby to the USB switch unit 22 via the universal serial bus. In another implementation, when the multi-host touch control display device 20 operates in the non-on-screen display mode, once the screen adjustment enabling signal is not received by the touch screen unit 21 via the serial peripheral interface bus, the touch screen unit 21 will transmit the touch control signal generated thereby directly to the USB switch unit 22 via the universal serial bus. In other words, it is not necessary for the monitor scaler 231 to transmit the screen adjustment disabling signal to the touch screen unit 21 when leaving the on-screen display mode to enter the non-on-screen display mode.

When the multi-host touch control display device 20 operates in the non-on-screen display mode, and when it is detected by the monitor scaler 231 that the screen displayed on the touch screen unit 21 corresponds to data provided by the multimedia device 91, the monitor scaler 231 provides a setup command to the USB switch unit 22 via the inter-integrated circuit bus for the USB switch unit 22 to enable transmission between the touch screen unit 21 and the multimedia device 91, such that the touch screen unit 21 is associated with the multimedia device 91 to enable touch control of the multimedia device 91.

When the multi-host touch control display device 20 operates in the non-on-screen display mode, and when it is detected by the monitor scaler 231 that the screen displayed on the touch screen unit 21 corresponds to data provided by the computer 92, the monitor scaler 231 provides a setup command to the USB switch unit 22 via the inter-integrated circuit bus for the USB switch unit 22 to enable transmission between the touch screen unit 21 and the computer 92, such that the touch screen unit 21 is associated with the computer 92 to enable touch control of the computer 92.

In summary, during operation of the multi-host touch control display device 10, 20 of the present invention, with the collaboration between the switch unit 11, 21 and the control unit 13, 23, the touch control functionality of the touch screen unit 11, 21 can be flexibly provided to multiple host devices 90 for performing their respective control operations. Therefore, it is not necessary for each host device 90 to have a proprietary touch control mechanism of its own, thereby significantly simplifying the touch control mechanism in a multiple-host-device environment and reducing the cost for implementing the same.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A multi-host touch control display device to be connected to a plurality of host devices for touch controlling the host devices, said multi-host touch control display device comprising:
a control unit for providing a switch control signal;
a touch screen unit for generating a touch control signal according to a touch event; and
a switch unit coupled electrically to said control unit for receiving the switch control signal therefrom, further coupled electrically to said touch screen unit, and to be coupled electrically to the host devices, said switch unit being operable to enable transmission between said touch screen unit and a selected one of the host devices according to the switch control signal received from said control unit such that said touch screen unit is able to transmit the touch control signal generated thereby to the selected one of the host devices.

2. The multi-host touch control display device as claimed in claim 1, wherein:
said control unit includes a monitor scaler coupled electrically to said touch screen unit and said switch unit, connection between said monitor scaler and said touch screen unit being established via a serial peripheral interface (SPI) bus; and
said multi-host touch control display device is operable in an on-screen display (OSD) mode, where said monitor scaler transmits a screen adjustment enabling signal to said touch screen unit via the serial peripheral interface bus so as to enable said touch screen unit to transmit the touch control signal generated thereby to said monitor scaler via the serial peripheral interface bus, said monitor scaler scaling a screen displayed on said touch screen unit according to the touch control signal.

3. The multi-host touch control display device as claimed in claim 2, wherein said switch unit is a universal serial bus (USB) switch unit.

4. The multi-host touch control display device as claimed in claim 3, wherein:
connection between said touch screen unit and said USB switch unit is established via a universal serial bus; and
said multi-host touch control display device is further operable in a non-on-screen display mode, where said monitor scaler transmits a screen adjustment disabling signal to said touch screen unit via said serial peripheral interface bus such that said touch screen unit is able to transmit the touch control signal generated thereby to said USB switch unit via said universal serial bus.

5. The multi-host touch control display device as claimed claim 3, wherein:
connection between said touch screen unit and said USB switch unit is established via a universal serial bus; and
said multi-host touch control display device is further operable in a non-on-screen display mode, where said touch screen unit is enabled to transmit the touch control signal generated thereby to said USB switch unit via said universal serial bus.

6. The multi-host touch control display device as claimed in claim 4, one of the host devices being a multimedia device that is adapted to be coupled to said touch screen unit via an inter-integrated circuit (I2C) bus, wherein, when said multi-host touch control display device operates in the non-on-screen display mode, and when it is detected by said monitor scaler that the screen displayed on said touch screen unit corresponds to data provided by the multimedia device, said monitor scaler provides a setup command to said USB switch unit via said inter-integrated circuit bus for said USB switch unit to enable transmission between said touch screen unit and the multimedia device, such that said touch screen unit is associated with the multimedia device to enable touch control of the multimedia device.

7. The multi-host touch control display device as claimed in claim 4, one of the host devices being a computer that is adapted to be coupled to said touch screen unit via an inter-integrated circuit (I2C) bus, wherein, when said multi-host touch control display device operates in the non-on-screen display mode, and when it is detected by said monitor scaler that the screen displayed on said touch screen unit corresponds to data provided by the computer, said monitor scaler provides a setup command to said USB switch unit via said inter-integrated circuit bus for said USB switch unit to enable transmission between said touch screen unit and the computer, such that said touch screen unit is associated with the computer to enable touch control of the computer.

8. The multi-host touch control display device as claimed in claim 1, wherein said touch screen unit is associated with the selected one of the host devices and displays a screen based on data provided by the selected one of the host devices, the touch control signal generated by said touch screen unit being associated with a corresponding operation of the selected one of the host devices.
